(19) United States
(12) Patent Application Publication
(10) Pub. No.: US 2008/0014407 A1
(43) Pub. Date: Jan. 17, 2008

(54) Pressure-Sensitive Adhesive Sheet and Method of Producing the Same

(75) Inventors: Kiichiro Katoh, Saitama (JP); Kazuhiro Tsuda, Saitama (JP); Osamu Kanazawa, Saitama (JP)

Correspondence Address: POSZ LAW GROUP, PLC, 12040 SOUTH LAKES DRIVE, SUITE 101, RESTON, VA, 20191, US

(73) Assignee: LINTEC CORPORATION, Tokyo (JP)

(21) Appl. No.: 11/597,718

(22) PCT Filed: Feb. 24, 2005
(86) PCT No.: PCT/JP05/03022

§ 371 Date: Feb. 8, 2007

(30) Foreign Application Priority Data
May 31, 2004 (JP) 2004-161402

(51) Int. Cl. B32B 3/10; B29C 67/20

(52) U.S. Cl. 428/131; 264/400

(57) ABSTRACT

Laser ablation processing is carried out on a pressure-sensitive adhesive sheet comprising at least a substrate 11 and a pressure-sensitive adhesive layer 12, so as to form through-holes 2 having a diameter in the substrate 11 and the pressure-sensitive adhesive layer 12 of from 0.1 to 120 μm and a diameter at a surface of the substrate of from 0.1 to 40 μm at a hole density of from 30 to 50,000 per 100 cm². According to the pressure-sensitive adhesive sheet, air entrapment and blistering can be prevented or eliminated via the through-holes 2, and yet the appearance compares favorably with that of a pressure-sensitive adhesive sheet having no through-holes therein.

### TECHNICAL FIELD

The present invention relates to a pressure-sensitive adhesive sheet according to which air entrapment and blistering can be prevented or eliminated, and a method of producing such a pressure-sensitive adhesive sheet.

### BACKGROUND ART

When sticking a pressure-sensitive adhesive sheet onto an adherend by hand, entrapment of air between the adherend and the pressure-sensitive adhesive surface may occur, marring the appearance of the pressure-sensitive adhesive sheet. Such air entrapment is particularly prone to occur in the case that the pressure-sensitive adhesive sheet has a large area.

To eliminate problems with appearance of a pressure-sensitive adhesive sheet due to air entrapment, another pressure-sensitive adhesive sheet may be stuck on in place of the preceded pressure-sensitive adhesive sheet, or the attached pressure-sensitive adhesive sheet may be peeled off and then reattached, or a hole may be made with a needle in a blistered portion of the pressure-sensitive adhesive sheet so as to allow the air to escape. However, in the case of sticking on in place of pressure-sensitive adhesive sheet, effort is required, and furthermore the cost is increased; moreover, in the case of reattaching the original pressure-sensitive adhesive sheet, problems often arise such as the pressure-sensitive adhesive sheet tearing, or wrinkles forming on the surface, or the adhesiveness dropping. On the other hand, the method of making a hole with a needle mars the appearance of the pressure-sensitive adhesive sheet.

To prevent air entrapment from occurring, there is a method in which water is put onto the adherend or the pressure-sensitive adhesive surface in advance before the two are stuck together; however, in the case of sticking on a pressure-sensitive adhesive sheet having large dimensions such as a safety film stuck onto a window, a decorative film or a marking film, much time and effort is required. Moreover, there is a method in which air entrapment is prevented from occurring by sticking on the pressure-sensitive adhesive sheet using a device rather than by hand; however, depending on the use of the pressure-sensitive adhesive sheet or the site or shape of the adherend, it may not be possible to use such a device for sticking on the pressure-sensitive adhesive sheet.

Meanwhile, a resin material such as an acrylic resin, an ABS resin, a polystyrene resin or a polycarbonate resin may emit a gas upon heating or even with no heating; in the case of sticking a pressure-sensitive adhesive sheet onto an adherend made of such a resin material, blistering may occur on the pressure-sensitive adhesive sheet due to the gas emitted from the adherend.

Moreover, in the case of sticking a pressure-sensitive adhesive sheet onto an adherend made of a resin through which gas readily permeates, gas that has permeated through may build up between the adherend and the pressure-sensitive adhesive sheet, so that the pressure-sensitive adhesive sheet blisters or peels off. For example, in the case that a marking sheet is stuck onto a motorbike gasoline tank made of polyethylene resin, vapor of gasoline in the gasoline tank may vaporize so as to permeate through the polyethylene resin layer of the gasoline tank, so that the marking sheet blisters or peels off, bringing about an undesirable situation such as the appearance being marred.

To solve such problems, with a pressure-sensitive adhesive sheet described in Japanese Patent Application Laid-open No. H2-107682, a substrate and a pressure-sensitive adhesive layer are subjected to punching processing using a blade die and a hole die so as to form through-holes of diameter from 0.2 to 1.0 mm therein, and with a pressure-sensitive adhesive sheet described in Japanese Utility Model Application Laid-open No. H4-100235, a substrate and a pressure-sensitive adhesive layer are subjected to perforation processing using a hot needle so as to form through-holes of diameter from 0.05 to 0.15 mm therein; air or gas escapes from these through-holes to the outside, whereby air entrapment and blistering of the pressure-sensitive adhesive sheet are prevented.

### DISCLOSURE OF THE INVENTION

### Problem to be Solved by the Invention

However, with the above pressure-sensitive adhesive sheets, the through-holes can be seen with the naked eye, and hence the appearance of the pressure-sensitive adhesive sheet is not necessarily good. In particular, in the case of forming the through-holes using a hot needle as with the pressure-sensitive adhesive sheet described in Japanese Utility Model Application Laid-open No. H4-100235, portions where the substrate melts and thus rises up mar the appearance of the pressure-sensitive adhesive sheet.

Moreover, with the above pressure-sensitive adhesive sheets, there has been a problem that if liquid such as water or gasoline becomes attached to the pressure-sensitive adhesive sheet after the pressure-sensitive adhesive sheet has been stuck onto an adherend, then this liquid enters into the through-holes, causing the through-hole portions (portions around the peripheries of the through-holes) to swell or the like so that the appearance of the pressure-sensitive adhesive sheet is marred.

The present invention has been devised in view of the above state of affairs; it is an object of the present invention to provide a pressure-sensitive adhesive sheet according to which air entrapment and blistering can be prevented or eliminated via through-holes, and yet the appearance compares favorably with that of a pressure-sensitive adhesive sheet having no through-holes therein, and a method of producing such a pressure-sensitive adhesive sheet.

### Means for Solving the Problem

To attain the above object, firstly, the present invention provides a pressure-sensitive adhesive sheet comprising at least a substrate and a pressure-sensitive adhesive layer, the pressure-sensitive adhesive sheet having formed therein a plurality of through-holes passing through from one surface to the other surface of the pressure-sensitive adhesive sheet, wherein the through-holes have a diameter in the substrate and the pressure-sensitive adhesive layer of from 0.1 to 120 μm, the through-holes have a diameter at a surface of the substrate of from 0.1 to 40 μm, the through-holes have a hole density of from 30 to 50,000 per 100 cm², and the through-holes are formed through laser ablation processing (invention 1).

Note that in the present specification, “sheet” is deemed to include the idea of a film, and “film” is deemed to include the idea of a sheet.

According to the pressure-sensitive adhesive sheet of the above inventions (inventions 1), air between an adherend and the pressure-sensitive adhesive surface escapes from the through-holes to the outside of the pressure-sensitive adhesive sheet front surface, and hence air tends not to be caught up when sticking the pressure-sensitive adhesive sheet to the adherend, i.e. air entrapment can be prevented from occurring. Even if air is caught up so that air entrapment occurs, by re-pressing the air-entrapped portion or an air-entrapped portion surrounding portion including the air-entrapped portion, the air can be made to escape from the through-holes to the outside of the pressure-sensitive adhesive sheet front surface, thus eliminating the air entrapment. Moreover, even if gas is emitted from the adherend after the pressure-sensitive adhesive sheet has been stuck onto the adherend, the gas will escape from the through-holes to the outside of the pressure-sensitive adhesive sheet front surface, whereby blistering can be prevented from occurring.

Moreover, due to the through-holes being formed through laser ablation processing, there is no attachment of melted matter so-called “dross” around the peripheries of the through-holes and no thermal deformation at the surface of or inside the pressure-sensitive adhesive sheet, and therefore the through-holes have uniform shape, in addition, due to the diameter at the surface of the substrate being not more than 40 μm, the through-holes cannot be seen with the naked eye at the substrate surface; the appearance is thus no different to that of a pressure-sensitive adhesive sheet having no through-holes therein. This is not affected by the nature of the substrate, the through-holes not being visible with the naked eye at the substrate surface even in the case of a substrate for which through-holes would ordinarily be readily visible, for example a substrate having high glossiness, a substrate having a not very high contrast ratio, or a substrate having high lightness.

Moreover, for the above pressure-sensitive adhesive sheet, even in the case that liquid such as water or gasoline becomes attached to the pressure-sensitive adhesive sheet after the pressure-sensitive adhesive sheet has been stuck onto an adherend, entering the liquid into the through-holes and swelling the through-hole portions (portions around the peripheries of the through-holes) can be prevented, whereby the good appearance of the pressure-sensitive adhesive sheet is maintained.

In the case of the above invention (invention 1), the diameter of the through-holes preferably decreases gradually from a rear surface of the pressure-sensitive adhesive sheet to a front surface of the pressure-sensitive adhesive sheet (invention 2). Through the diameter of the through-holes changing in this way, the through-holes become yet less visible at the front surface of the pressure-sensitive adhesive sheet, and hence the appearance of the pressure-sensitive adhesive sheet is further improved.

Secondly, the present invention provides a method of producing a pressure-sensitive adhesive sheet, comprising carrying out laser ablation processing on a pressure-sensitive adhesive sheet comprising at least a substrate and a pressure-sensitive adhesive layer, so as to form through-holes having a diameter in the substrate and the pressure-sensitive adhesive layer of from 0.1 to 120 μm and a diameter at a surface of the substrate of from 0.1 to 40 μm at a hole density of from 30 to 50,000 per 100 cm² (invention 3).

According to the above invention (invention 3), through-holes of uniform shape can be formed with no attachment of dross and no thermal deformation, and hence the formed through-holes cannot be seen with the naked eye at the substrate surface; as a result, a pressure-sensitive adhesive sheet having an appearance no different to that of a pressure-sensitive adhesive sheet having no through-holes therein can be obtained. Moreover, for the pressure-sensitive adhesive sheet obtained, even in the case that liquid such as water or gasoline becomes attached to the pressure-sensitive adhesive sheet after the pressure-sensitive adhesive sheet has been stuck onto an adherend, entering the liquid into the through-holes and swelling the through-hole portions (portions around the peripheries of the through-holes) can be prevented, whereby the good appearance of the pressure-sensitive adhesive sheet is maintained.

In the case of the above invention (invention 3), the laser ablation processing can be carried out using a laser beam having a wavelength of from 150 to 352 nm and a pulse width of from 2 to 300 ns (invention 4) or an excimer laser (invention 5), or using a laser beam having a wavelength of from 150 to 900 nm and a pulse width of from 10 to 900 fs (invention 6) or a femtosecond laser (invention 7).

In the case of the above inventions (inventions 3 to 7), the laser ablation processing is preferably carried out from a rear surface side of the pressure-sensitive adhesive sheet (invention 8). Here, the “rear surface of the pressure-sensitive adhesive sheet” means the surface on the opposite side to the front surface of the pressure-sensitive adhesive sheet, being the bottom surface of the release liner in the case that a release liner is present as a lowermost layer, or the pressure-sensitive adhesive surface of the pressure-sensitive adhesive layer in the case that the pressure-sensitive adhesive layer is exposed with no release liner being present.

When the through-holes are formed through the laser ablation processing, the through-holes often become tapered, narrowing toward a front tip thereof, and hence by carrying out the laser ablation processing from the rear surface side of the pressure-sensitive adhesive sheet, the diameter of the through-holes can be made to be smaller on the front surface side of the pressure-sensitive adhesive sheet than on the rear surface side of the pressure-sensitive adhesive sheet; the through-holes thus become yet less visible at the front surface of the pressure-sensitive adhesive sheet, and hence the appearance of the pressure-sensitive adhesive sheet is further improved.

### ADVANTAGEOUS EFFECT OF THE INVENTION

According to the present invention, there is provided a pressure-sensitive adhesive sheet according to which air entrapment and blistering can be prevented or eliminated via through-holes, and yet the through-holes cannot be seen with the naked eye at the substrate surface. Regardless of the nature of the substrate, this pressure-sensitive adhesive sheet has a very good appearance, the appearance not differing to that of a pressure-sensitive adhesive sheet having no through-holes therein. Moreover, the good appearance of the pressure-sensitive adhesive sheet can be maintained even under an environment in which liquid becomes attached after the pressure-sensitive adhesive sheet has been stuck.

### BRIEF DESCRIPTION OF THE DRAWINGS

FIG. 1 is a sectional view of a pressure-sensitive adhesive sheet according to an embodiment of the present invention;

FIG. 2 is an enlarged sectional view of part of the pressure-sensitive adhesive sheet according to the above embodiment; and

FIG. 3 consists of sectional views showing an example of a method of producing the pressure-sensitive adhesive sheet according to the above embodiment.

### EXPLANATION OF REFERENCE NUMERALS

1: Pressure-sensitive adhesive sheet
11: Substrate
12: Pressure-sensitive adhesive layer
13: Release liner
1A: Pressure-sensitive adhesive sheet front surface
1B: Pressure-sensitive adhesive surface
2: Through-hole

### BEST MODE FOR CARRYING OUT THE INVENTION

Following is a description of an embodiment of the present invention.

[Pressure-Sensitive Adhesive Sheet]

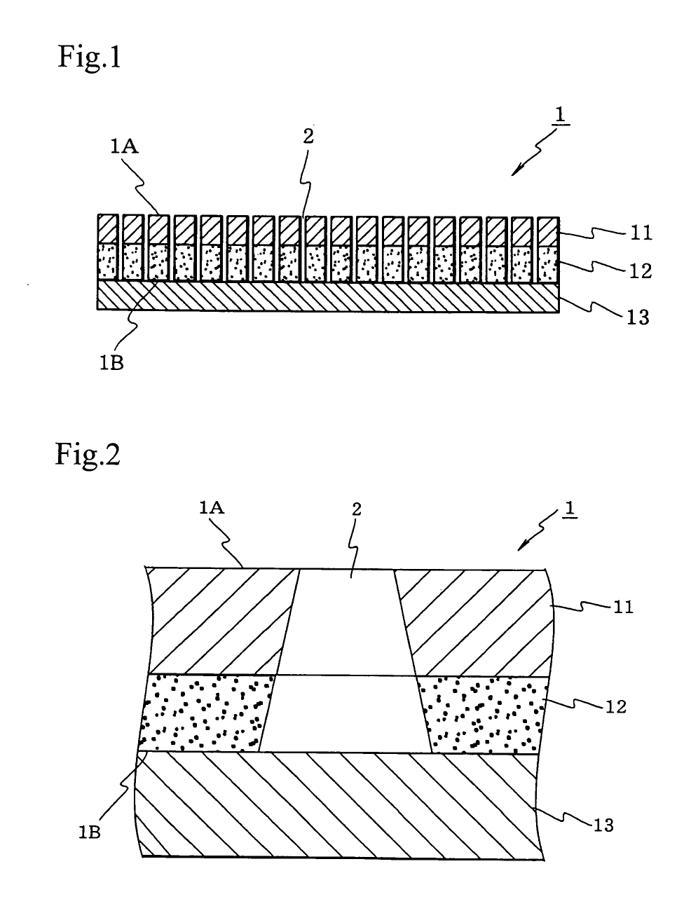

FIG. 1 is a sectional view of a pressure-sensitive adhesive sheet according to an embodiment of the present invention.

As shown in FIG. 1, the pressure-sensitive adhesive sheet 1 according to the present embodiment comprises a substrate 11, a pressure-sensitive adhesive layer 12, and a release liner 13 laminated on one another. Note, however, that the release liner 13 is peeled off when using the pressure-sensitive adhesive sheet 1.

A plurality of through-holes 2 that penetrate through the substrate 11 and the pressure-sensitive adhesive layer 12 and thus pass from a pressure-sensitive adhesive sheet front surface 1A to a pressure-sensitive adhesive surface 1B are formed in the pressure-sensitive adhesive sheet 1, the through-holes 2 being formed through laser ablation processing. The laser ablation processing will be described in detail later.

There are no particular limitations on the material of the substrate 11 so long as this is a material in which the through-holes 2 can be formed through the laser ablation processing; examples include a resin film, a metal film, a metallized resin film, paper, or a laminate of the above. These materials may contain any of various additives such as inorganic fillers, organic fillers, and ultraviolet absorbers.

The surface of the material may have a decorative layer formed thereon by a method such as printing, painting, transfer printing, vapor deposition, or sputtering, or may have formed thereon an undercoat layer such as an adhesion facilitating coat for forming such a decorative layer, or a gloss adjusting coat, or may have formed thereon a topcoat layer such as a hard coat, an antifouling coat, or a surface roughness or specular gloss adjusting coat. Moreover, such a decorative layer, undercoat layer or topcoat layer may be formed over the whole of the material, or may be formed on only part of the material.

As a resin film, there can be used, for example, a film or a foamed film made of a resin such as a polyolefin such as polyethylene or polypropylene, a polyester such as polyethylene terephthalate or polybutylene terephthalate, polyvinyl chloride, polystyrene, a polyurethane, a polycarbonate, a polyamide, a polyimide, polymethyl methacrylate, polybutene, polybutadiene, polymethylpentene, an ethylene-vinyl acetate copolymer, an ethylene-(meth)acrylic acid copolymer, an ethylene-(meth)acrylate ester copolymer, an ABS resin, or an ionomer resin, or a thermoplastic elastomer containing a component such as a polyolefin, a polyurethane, polystyrene, polyvinyl chloride or a polyester, or a laminated film of the above. As the resin film, a commercially available one may used, or one formed by a casting method or the like using a casting sheet may be used. Moreover, as paper, there can be used, for example, woodfree paper, glassine paper, coated paper, laminated paper, or the like.

There are no particular limitations on the above casting sheet, for example, any of various types of paper, or a resin film such as polyethylene terephthalate, polypropylene, polyethylene or the like that has been subjected to release treatment with a release agent of a silicone type, a polyester type, an acrylic type, an alkyd type, a urethane type or the like or a synthetic resin can be used. The thickness of the casting sheet is generally approximately 10 to 200 μm, preferably approximately 25 to 150 μm.

In the present embodiment, there are no particular limitations on the glossiness (surface roughness), contrast ratio or lightness of the substrate 11, but the substrate 11 may be such that through-holes would ordinarily be readily visible, for example one having high glossiness (e.g. surface roughness (Ra) of less than 0.15 μm, or specular gloss Gs (60°) of not less than 80%), one having not very high contrast ratio (e.g. a contrast ratio of less than 90%), or one having high lightness (e.g. in the L* a* b* color system, in the case that the chroma (C*) is not more than 60, a lightness (L*) greater than 60, or in the case that the chroma (C*) is greater than 60, a lightness (L*) greater than 85).

Here, the surface roughness (Ra: Roughness average) is in accordance with JIS B0601. The specular gloss Gs (60°) is in accordance with JIS Z8741. L★, a*, b* and C* are in accordance with JIS Z8729, the relationship between C*, a★ and b* being given by C*=(a*²+b*²)^{1/2}. The contrast ratio is in accordance with JIS K5400.

The thickness of the substrate 11 is generally approximately from 1 to 500 μm, preferably from 3 to 300 μm, but may be changed as appropriate in accordance with the use of the pressure-sensitive adhesive sheet 1.

There are no particular limitations on the type of the pressure-sensitive adhesive constituting the pressure-sensitive adhesive layer 12 so long as this pressure-sensitive adhesive is a material in which the through-holes 2 can be formed through the laser ablation processing; the pressure-sensitive adhesive may be any of an acrylic type, a polyester type, a polyurethane type, a rubber type, a silicone type, or the like. Moreover, the pressure-sensitive adhesive may be any of an emulsion type, a solvent type, or a solvent-less type, and may be either a crosslinked type or a non-crosslinked type.

The thickness of the pressure-sensitive adhesive layer 12 is generally approximately from 1 to 300 μm, preferably from 5 to 100 μm, but may be changed as appropriate in accordance with the use of the pressure-sensitive adhesive sheet 1.

There are no particular limitations on the material of the release liner 13; for example, a film or foamed film made of a resin such as polyethylene terephthalate, polypropylene or polyethylene, or paper such as glassine, coated paper or laminated paper that has been subjected to release treatment with a release agent such as a silicone type one, a fluorine type one or a long chain alkyl group-containing carbamate can be used.

The thickness of the release liner 13 is generally approximately from 10 to 250 μm, preferably approximately from 20 to 200 μm. Moreover, the thickness of the release agent in the release liner 13 is generally from 0.05 to 5 μm, preferably from 0.1 to 3 μm.

In the present embodiment, the through-holes 2 have a diameter in the substrate 11 and the pressure-sensitive adhesive layer 12 of from 0.1 to 120 μm, preferably from 1 to 100 μm, and a diameter at the surface of the substrate 11 of from 0.1 to 40 μm, preferably from 1 to 38 μm.

Through the diameter of the through-holes 2 satisfying the above conditions, air or gas can readily escape from the through-holes 2, and yet the through-holes 2 cannot be seen with the naked eye on the pressure-sensitive adhesive sheet front surface 1A. In particular, the through-holes 2 are formed through laser ablation processing, and hence through-holes 2 of uniform shape can be formed with no attachment of melted matter known as “dross” around the peripheries of the through-holes 2 and no thermal deformation at the surface of or inside the pressure-sensitive adhesive sheet 1; consequently, even if the substrate 11 has high glossiness, not very high contrast ratio, or high lightness, if the diameter of the through-holes 2 satisfies the above conditions, then the through-holes 2 cannot be seen with the naked eye.

The diameter of the through-holes 2 may be constant in the thickness direction of the pressure-sensitive adhesive sheet 1, or may change in the thickness direction of the pressure-sensitive adhesive sheet 1. In the case that the diameter of the through-holes 2 changes in the thickness direction of the pressure-sensitive adhesive sheet 1, the diameter of the through-holes 2 preferably decreases gradually from the pressure-sensitive adhesive surface 1B to the pressure-sensitive adhesive sheet front surface 1A as shown in FIG. 2. Through the diameter of the through-holes 2 changing in this way, the through-holes 2 become yet less visible at the pressure-sensitive adhesive sheet front surface 1A.

The hole density of the through-holes 2 is in a range of 30 to 50,000 per 100 cm², preferably 100 to 10,000 per 100 cm². If the hole density of the through-holes 2 is less than 30 per 100 cm², then it will be difficult for air or gas to escape, whereas if the hole density of the through-holes 2 is greater than 50,000 per 100 cm², then the mechanical strength of the pressure-sensitive adhesive sheet 1 will drop.

Note that the through-holes 2 in the pressure-sensitive adhesive sheet 1 according to the present embodiment pass through only the substrate 11 and the pressure-sensitive adhesive layer 12, but the through-holes 2 may also pass through the release liner 13.

Moreover, the pressure-sensitive adhesive sheet 1 according to the present embodiment has the release liner 13, but there is no limitation to this in the present invention; the pressure-sensitive adhesive sheet 1 may have no release liner 13. Furthermore, there are no particular limitations on the size, shape and soon of the pressure-sensitive adhesive sheet 1 according to the present embodiment. For example, the pressure-sensitive adhesive sheet 1 may be a tape comprising only the substrate 11 and the pressure-sensitive adhesive layer 12 (a pressure-sensitive adhesive tape), and may also be wound up into a roll.

[Production of Pressure-Sensitive Adhesive Sheet]

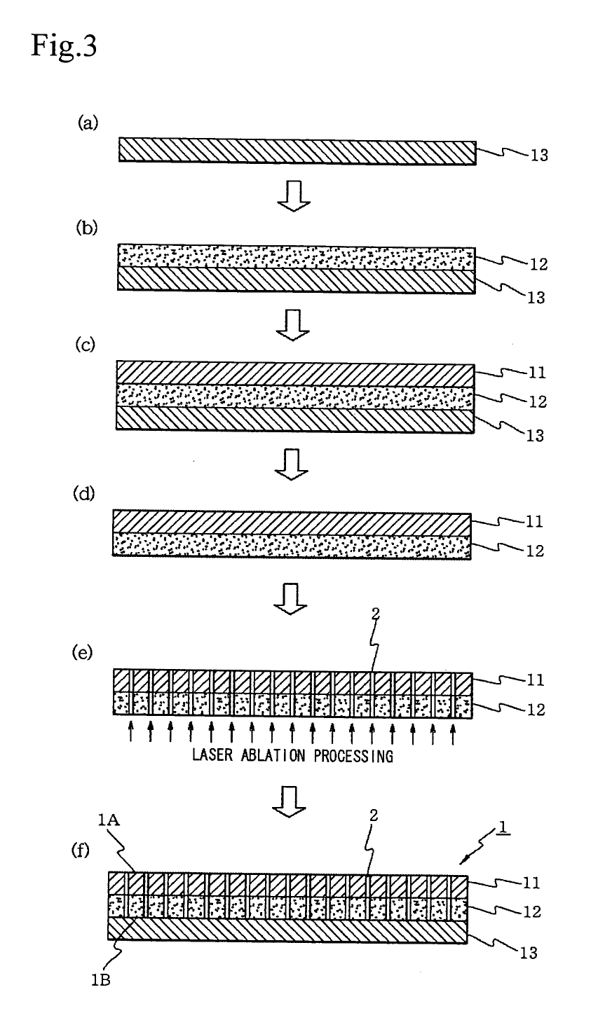

An example of a method of producing the pressure-sensitive adhesive sheet 1 according to the above embodiment will now be described with reference to FIGS. 3(a) to (d).

In the present producing method, firstly, as shown in FIGS. 3(a) and (b), the pressure-sensitive adhesive layer 12 is formed on the release treated surface of the release liner 13. The pressure-sensitive adhesive layer 12 may be formed by preparing a coating agent containing the pressure-sensitive adhesive that will constitute the pressure-sensitive adhesive layer 12, and also a solvent if desired, applying the coating agent onto the release treated surface of the release liner 13 using a coater such as a roll coater, a knife coater, a roll knife coater, an air knife coater, a die coater, a bar coater, a gravure coater, or a curtain coater, and drying.

Next, as shown in FIG. 3(c), the substrate 11 is superposed onto the surface of the pressure-sensitive adhesive layer 12, thus obtaining a laminate comprising the substrate 11, the pressure-sensitive adhesive layer 12, and the release liner 13. Then, as shown in FIG. 3(d), the release liner 13 is peeled off from the pressure-sensitive adhesive layer 12, and then, as shown in FIG. 3(e), the through-holes 2 are formed by carrying out laser ablation processing on the laminate comprising the substrate 11 and the pressure-sensitive adhesive layer 12. Finally, as shown in FIG. 3(f), the release liner 13 is stuck back onto the pressure-sensitive adhesive layer 12.

Among laser processing, laser processing using a carbon dioxide (CO₂) laser, a YAG laser or the like is so-called laser thermal processing, in which holes are formed in the workpiece through the light energy being converted into thermal energy. Consequently, if such laser thermal processing is carried out on the pressure-sensitive adhesive sheet, then dross may become attached around-the peripheries of the through-holes 2, or thermal deformation may take place at the surface of or inside the pressure-sensitive adhesive sheet, whereby the through-holes 2 or peripheral parts around the through-holes 2 may become readily visible.

In contrast with this, with laser ablation processing, if an absorption wavelength of the material of the workpiece and the wavelength of the laser match one another, then the material of the workpiece is sublimated without passing through a liquid state, so as to form holes in the workpiece. Ordinary organic materials have a strong absorption wavelength in the ultraviolet region, and hence upon irradiating a workpiece made of an organic material with a laser beam having wavelength matching this absorption wavelength, chemical bonds in the constituent molecules of the organic material are broken instantaneously at a portion irradiated with the laser, and hence this portion is decomposed and dispersed, so that a hole is formed in the workpiece.

According to such laser ablation processing, through-holes 2 of uniform shape can thus be formed with no attachment of dross around the peripheries of the through-holes 2 and no thermal deformation at the surface of or inside the pressure-sensitive adhesive sheet 1; consequently, even if the substrate 11 has high glossiness, not very high contrast ratio, or high lightness, the through-holes 2 cannot be readily seen with the naked eye.

The laser ablation processing is preferably carried out using an excimer laser or a femtosecond laser. Here, included under an excimer laser is an ultraviolet femtosecond laser. Specifically, the laser ablation processing is preferably carried out using a laser beam having a wavelength of from 150 to 352 nm and a pulse width of from 2 to 300 ns, or a laser beam having a wavelength of from 150 to 900 nm and a pulse width of from 10 to 900 fs.

Examples of an excimer laser are an XeCl excimer laser having an oscillation wavelength of 308 nm, and a KrF excimer laser having an oscillation wavelength of 248 nm. An example of a femtosecond laser is a Ti:Sapphire laser oscillating with a central wavelength around 800 nm.

In the present producing method, the pressure-sensitive adhesive layer 12 is irradiated with the laser directly from the pressure-sensitive adhesive layer 12 side. By carrying out the laser ablation processing from the pressure-sensitive adhesive layer 12 side in this way, even if the through-holes 2 become tapered as shown in FIG. 2, the diameter of the through-holes 2 can be made to be smaller on the substrate 11 side than on the release liner 13 side, and it is easy to control the diameter of the through-holes 2 at the surface of the substrate 11 to be in the range described earlier (0.1 to 40 μm).

Moreover, by temporarily stripping off the release liner 13 and irradiating the pressure-sensitive adhesive layer 12 with the laser directly without the release liner 13 present therebetween, the laser irradiation time can be shortened, or the laser output energy can be reduced, and hence the through-holes 2 can be formed efficiently.

In the present producing method, as the substrate 11, one formed by a casting method or the like using a casting sheet may be used; in this case, the casting sheet may be laminated on the surface of the substrate 11. Moreover, in the present producing method, before carrying out the laser ablation processing, a peelable protective sheet may be laminated onto the surface of the substrate (on which a casting sheet has not been laminated) 11 at a desired stage. As the protective sheet, for example a publicly known pressure-sensitive adhesive protective sheet comprising a substrate and a removable pressure-sensitive adhesive layer can be used.

Furthermore, in the present producing method, the pressure-sensitive adhesive layer 12 was formed on the release liner 13, and then the substrate 11 was stuck onto the formed pressure-sensitive adhesive layer 12; however, there is no limitation to this in the present invention, for example the pressure-sensitive adhesive layer 12 may be coated on the substrate 11 directly. Moreover, the laser ablation processing may be carried out from the side of the substrate 11 or a casting sheet or protective sheet as described above.

[Use of Pressure-Sensitive Adhesive Sheet]

When sticking the pressure-sensitive adhesive sheet 1 onto an adherend, the release liner 13 is peeled off from the pressure-sensitive adhesive layer 12, the pressure-sensitive adhesive surface 1B of the exposed pressure-sensitive adhesive layer 12 is made to be in close contact with the adherend, and then the pressure-sensitive adhesive sheet 1 is pressed onto the adherend. At this time, air between the adherend and the pressure-sensitive adhesive surface 1B of the pressure-sensitive adhesive layer 12 escapes from the through-holes 2 formed in the pressure-sensitive adhesive sheet 1 to the outside of the pressure-sensitive adhesive sheet front surface 1A, and hence air tends not to be caught up between the adherend and the pressure-sensitive adhesive surface 1B, i.e. air entrapment is prevented from occurring. Even if air is caught up so that air entrapment occurs, by re-pressing the air-entrapped portion or an air-entrapped portion surrounding portion including the air-entrapped portion, the air can be made to escape from the through-holes 2 to the outside of the pressure-sensitive adhesive sheet front surface 1A, thus eliminating the air entrapment. Such elimination of air entrapment is possible even after a long time has elapsed after the sticking on of the pressure-sensitive adhesive sheet 1.

Moreover, even if gas is emitted from the adherend or gas passes through the adherend after the pressure-sensitive adhesive sheet 1 has been stuck onto the adherend, this gas will escape from the through-holes 2 formed in the pressure-sensitive adhesive sheet 1 to the outside of the pressure-sensitive adhesive sheet front surface 1A, whereby the pressure-sensitive adhesive sheet 1 is prevented from blistering.

As described above, according to the pressure-sensitive adhesive sheet 1, air entrapment and blistering can be prevented or eliminated via the through-holes 2, and yet the through-holes 2 cannot be seen with the naked eye, and hence the appearance of the pressure-sensitive adhesive sheet 1 is very good, not differing at all to that of a pressure-sensitive adhesive sheet having no through-holes 2 therein.

Moreover, according to the pressure-sensitive adhesive sheet 1 described above, even in the case that liquid becomes attached to the pressure-sensitive adhesive sheet 1 after the pressure-sensitive adhesive sheet 1 has been stuck onto an adherend, there will be no adverse effects due to the through-holes 2, the good appearance of the pressure-sensitive adhesive sheet 1 being maintained.

### EXAMPLES

Following is a more detailed description of the present invention through examples and so on; however, the scope of the present invention is not limited by these examples and so on.

### Example 1

A solvent type acrylic pressure-sensitive adhesive (made by LINTEC CORPORATION, PK) coating agent was applied using a knife coater such that the thickness after drying would be 30 μm onto the release treated surface of a release liner (made by LINTEC CORPORATION, FPM-11, thickness: 175 μm) obtained by laminating both surfaces of woodfree paper with a polyethylene resin and applying a silicone type release agent onto one surface, and drying was carried out for 1 minute at 90° C. A black opaque substrate (thickness: 100 μm) made of a polyvinyl chloride resin having a surface roughness (Ra) of 0.266 μm, a specular gloss Gs (60°) of 37.2%, a chroma (C*) in the L*a*b* color system of 0.34 and a lightness (L*) of 26.56, and a contrast ratio of 99.9% was superposed onto the pressure-sensitive adhesive layer thus formed, whereby a laminate having a three-layer structure was obtained.

The measurement of the surface roughness (Ra) was carried out in accordance with JIS B0601, using an SV-3000S4 measurement apparatus made by MITUTOYO CORPORATION with a cutoff value λc of 0.8 mm and an evaluation length ln of 10 mm. The measurement of the specular gloss Gs (60°) was carried out in accordance with JIS Z8741, using a VG2000 gloss meter made by Nippon Denshoku Industries Co., Ltd. as the measurement apparatus. The measurement of the chroma (C*) and the lightness (L*) was carried out in accordance with JIS Z8729, by reflectometry using a simultaneous measurement type spectral color difference meter (made by Nippon Denshoku Industries Co., Ltd., SQ-2000) as the measurement apparatus, a white board (L*=92.47, a*=0.61, b*=2.90) as a sample-holding stage, and a C light source with a 2° field (C/2) as a light source. The measurement of the contrast ratio was carried out in accordance with JIS K5400, using a SPECTRAFLASH SF600 plus CTC (spectrophotometer) made by Datacolor International (DCI) as the measurement apparatus. These measurement methods were the same hereinafter.

The release liner was peeled off from the laminate, and the laminate was subjected to laser ablation processing from the pressure-sensitive adhesive layer side using an excimer laser with the conditions listed below, thus forming at a hole density of 2500 per 100 cm² through-holes having a diameter at the substrate surface of approximately 30 μm and a diameter at the pressure-sensitive adhesive surface of approximately 60 μm (the diameter being a maximum at the pressure-sensitive adhesive surface). The release liner was then superposed again onto the pressure-sensitive adhesive layer, whereby a pressure-sensitive adhesive sheet was obtained.

Conditions for Laser Ablation Processing Using Excimer Laser

Oscillator medium: KrF
Oscillation wavelength: 248 nm
Pulse width: 16 ns
Frequency: 197 Hz

### Example 2

Using as a casting sheet a polyethylene terephthalate film (thickness: 50 μm) one surface of which had been subjected to release treatment with an alkyd type release agent, a black opaque substrate (thickness: 100 μm) made of a polyurethane resin having a surface roughness (Ra) of 0.031 μm, a specular gloss Gs (60°) of 91.2%, a chroma (C*) in the L*a*b* color system of 0.21 and a lightness (L*) of 24.69, and a contrast ratio of 99.7% was formed using a casting method.

On the other hand, a pressure-sensitive adhesive layer was formed on a release liner as in Example 1, and then the pressure-sensitive adhesive layer and the above substrate with casting sheet were superposed together such that the pressure-sensitive adhesive layer and the opposite surface of the above substrate were attached firmly, whereby a laminate having a four-layer structure was obtained.

The release liner was peeled off from the laminate obtained, and the laminate was subjected to laser ablation processing as in Example 1 from the pressure-sensitive adhesive layer side, thus forming at a hole density of 2500 per 100 cm² through-holes having a diameter at the substrate surface of approximately 25 μm and a diameter at the pressure-sensitive adhesive surface of approximately 55 μm (the diameter being a maximum at the pressure-sensitive adhesive surface). The release liner was then superposed again onto the pressure-sensitive adhesive layer, whereby a pressure-sensitive adhesive sheet was obtained.

### Example 3

A pressure-sensitive adhesive sheet was produced as in Example 1, except that a black opaque substrate (thickness: 100 μm) made of an olefinic thermoplastic elastomer having a colorless transparent acrylic coating (thickness: 5 μm) on a surface thereof, and having a surface roughness (Ra) of 0.373 μm, a specular gloss Gs (60°) of 24.8%, a chroma (C*) of 0.34 and a lightness (L*) of 27.39 in the L*a*b* color system, and a contrast ratio of 99.3% was used as the substrate, and the through-holes were made to have a diameter at the substrate surface of approximately 25 μm and a diameter at the pressure-sensitive adhesive surface of approximately 65 μm.

### Example 4

A pressure-sensitive adhesive sheet was produced as in Example 1, except that a colorless transparent substrate (thickness: 25 μm) made of polyethylene terephthalate having a surface roughness (Ra) of 0.035 μm, a specular gloss Gs (60°) of 80.4%, and a contrast ratio of 8.0% was used as the substrate, and the through-holes were made to have a diameter at the substrate surface of approximately 15 μm and a diameter at the pressure-sensitive adhesive surface of approximately 45 μm.

### Example 5

A gray opaque substrate (thickness: 55 μm) made of a polyvinyl chloride resin having a surface roughness (Ra) of 0.216 μm, a specular gloss Gs (60°) of 28.5%, a chroma (C*) of 2.08 and a lightness (L*) of 65.21 in the L*a*b* color system, and a contrast ratio of 97.3% was formed on a casting sheet as in Example 2.

Using the substrate with casting sheet thus obtained, a pressure-sensitive adhesive sheet was produced as in Example 2, except that the through-holes were made to have a diameter at the pressure-sensitive adhesive surface of approximately 60 μm.

### Example 6

A laminate having a four-layer structure was produced as in Example 2, and then the release liner was peeled off from the laminate obtained, and the laminate was subjected to laser ablation processing from the pressure-sensitive adhesive layer side using a femtosecond laser with the conditions listed below, thus forming at a hole density of 2500 per 100 cm² through-holes having a diameter at the substrate surface of approximately 10 μm and a diameter at the pressure-sensitive adhesive surface of approximately 30 μm (the diameter being a maximum at the pressure-sensitive adhesive surface). The release liner was then superposed again onto the pressure-sensitive adhesive layer, whereby a pressure-sensitive adhesive sheet was obtained.

Conditions for Laser Ablation Processing Using Femtosecond Laser

Oscillator medium: Ti:sapphire
Oscillation wavelength: 800 nm
Pulse width: 150 fs
Frequency: 1 kHz

### Comparative Example 1

A pressure-sensitive adhesive sheet was produced as in Example 2, except that laser thermal processing using a CO₂ laser with the conditions listed below was carried out instead of the laser ablation processing using the excimer laser, and the through-holes were made to have a diameter at the substrate surface of approximately 35 μm and a diameter at the pressure-sensitive adhesive surface of approximately 90 μM.

Conditions for Laser Thermal Processing Using CO₂ Laser

Oscillator medium: CO₂
Oscillation wavelength: 9.4 μm
Pulse width: 40 μs
Frequency: 1 kHz

### Comparative Example 2

A pressure-sensitive adhesive sheet was produced as in Example 4, except that laser thermal processing using a CO₂ laser (with conditions as in Comparative Example 1) was carried out instead of the laser ablation processing using the excimer laser, and the through-holes were made to have a diameter at the substrate surface of approximately 35 μm and a diameter at the pressure-sensitive adhesive surface of approximately 85 μm.

[Test]

For each of the pressure-sensitive adhesive sheets obtained in the Examples and the Comparative Examples, an air entrapment removability test and a hole visibility inspection were carried out as follows. The results are shown in Table 1.

Air entrapment removability test: The pressure-sensitive adhesive sheet was cut to 50 mm×50 mm, had the casting sheet peeled off therefrom in the case that there was a casting sheet, and had the release liner peeled off therefrom, and was then stuck onto a melamine coated plate having therein a depression having the shape of part of a spherical surface with a diameter of 15 mm and a maximum depth of 1 mm (there was air entrapment between the depression and the pressure-sensitive adhesive sheet), and then the pressure-sensitive adhesive sheet was pressed on using a squeegee, and it was verified whether or not the air entrapment could be eliminated. Pressure-sensitive adhesive sheets for which the result was that the pressure-sensitive adhesive sheet followed the depression in the melamine coated plate and hence the air entrapment was eliminated were marked as “O”, and ones for which the pressure-sensitive adhesive sheet did not follow the depression in the melamine coated plate and hence the air entrapment was not eliminated (including ones for which even a small amount of air entrapment remained) were marked as “X”.

Hole visibility inspection: The pressure-sensitive adhesive sheet was cut to 30 mm×30 mm, had the casting sheet peeled off therefrom in the case that there was a casting sheet, and had the release liner peeled off therefrom, and was then stuck onto a white melamine coated plate, and it was inspected whether or not the existence of the through-holes could be discerned at the pressure-sensitive adhesive sheet front surface with the naked eye under indoor fluorescent lighting. The distance from the eyes to the pressure-sensitive adhesive sheet was made to be approximately 30 cm, and the angle from which the pressure-sensitive adhesive sheet was viewed was varied. Pressure-sensitive adhesive sheets for which the result was that the existence of the through-holes could not be discerned were marked as “O”, and ones for which the existence of the through-holes could be discerned were marked as “X”.

TABLE 1

| | Air | |
|---|---|---|
| | entrapment | Hole |
| | removability | visibility |
| | test | inspection |
| Example 1 | ◯ | ◯ |
| Example 2 | ◯ | ◯ |
| Example 3 | ◯ | ◯ |
| Example 4 | ◯ | ◯ |
| Example 5 | ◯ | ◯ |
| Example 6 | ◯ | ◯ |
| Comparative | ◯ | X |
| Example 1 | | |
| Comparative | ◯ | X |
| Example 2 | | |

For the pressure-sensitive adhesive sheets in which the through-holes were formed by laser ablation processing (Examples 1 to 6), there was no dross, thermal deformation, or the like, and the existence of the through-holes could not be discerned, and hence the appearance was very good. On the other hand, for the pressure-sensitive adhesive sheets in which the through-holes were formed by laser thermal processing (Comparative Examples 1 and 2), the existence of the through-holes could be discerned due to dross, thermal deformation, or other thermal effects, and hence the appearance was marred.

### INDUSTRIAL APPLICABILITY

The present invention can be favorably used in the case that air entrapment or blistering would generally be prone to occur with a pressure-sensitive adhesive sheet, for example in the case that the pressure-sensitive adhesive sheet has a large area, or the case that gas is emitted from the adherend, and a very good appearance with through-holes not being visible is required.

1. A pressure-sensitive adhesive sheet comprising at least a substrate and a pressure-sensitive adhesive layer, the pressure-sensitive adhesive sheet having formed therein a plurality of through-holes passing through from one surface to the other surface of the pressure-sensitive adhesive sheet, wherein
said through-holes have a diameter in said substrate and said pressure-sensitive adhesive layer of from 0.1 to 120 μm,
said through-holes have a diameter at a surface of said substrate of from 0.1 to 40 μm,
said through-holes have a hole density of from 30 to 50,000 per 100 cm^{2,} and
said through-holes are formed through laser ablation processing.

2. The pressure-sensitive adhesive sheet according to claim 1, wherein the diameter of said through-holes decreases gradually from a rear surface of the pressure-sensitive adhesive sheet to a front surface of the pressure-sensitive adhesive sheet.

3. A method of producing a pressure-sensitive adhesive sheet, comprising carrying out laser ablation processing on a pressure-sensitive adhesive sheet comprising at least a substrate and a pressure-sensitive adhesive layer, so as to form through-holes having a diameter in said substrate and said pressure-sensitive adhesive layer of from 0.1 to 120 μm and a diameter at a surface of said substrate of from 0.1 to 40 μm at a hole density of from 30 to 50,000 per 100 cm².

4. The method of producing a pressure-sensitive adhesive sheet according to claim 3, wherein a laser beam used in said laser ablation processing has a wavelength of from 150 to 352 nm, and a pulse width of from 2 to 300 ns.

5. The method of producing a pressure-sensitive adhesive sheet according to claim 3, wherein said laser ablation processing is carried out using an excimer laser.

6. The method of producing a pressure-sensitive adhesive sheet according to claim 3, wherein a laser beam used in said laser ablation processing has a wavelength of from 150 to 900 nm, and a pulse width of from 10 to 900 fs.

7. The method of producing a pressure-sensitive adhesive sheet according to claim 3, wherein said laser ablation processing is carried out using a femtosecond laser.

8. The method of producing a pressure-sensitive adhesive sheet according to any of claims 3 through 7, wherein said laser ablation processing is carried out from a rear surface side of the pressure-sensitive adhesive sheet.
